(19) United States
(12) Patent Application Publication
(10) Pub. No.: US 2009/0043695 A1
(43) Pub. Date: Feb. 12, 2009

(54) Method & system for facilitating charitable donor to donee matching

(76) Inventor: Robyn J. Hickey, Washington, DC (US)

Correspondence Address: REED SMITH LLP, Suite 1400, 3110 Fairview Park Drive, Falls Church, VA, 22042, US

(21) Appl. No.: 11/889,177

(22) Filed: Aug. 9, 2007

(51) Int. Cl. G06Q 40/00

(52) U.S. Cl. 705/39

(57) ABSTRACT

A method for facilitating charity donation matching, includes the steps of collecting information of potential donation receiving entities, inviting a potential donating entity to register contact information and donation criteria, prompting the potential donating entity to pay a matching surcharge, accepting the matching surcharge, matching the potential donating entity with one or more potential donation receiving entities and generating matching results, and providing the matching results to the potential donating entity.

### BACKGROUND OF THE INVENTION

1. Field of the Invention

The invention generally relates to a system for bridging between the private and public sectors with charity receiving entities, such as schools. In particular, the system works with private companies, government, community and nonprofit organizations to locate public (or private) schools or school systems in their local area, region, state, or on a national basis to support.

2. Description of the Related Art

Most charitable originations, such as Red Cross, Purple Hearts, Salvation Army, Make A Wish Foundation, etc. facilitate three-party charitable money and/or gifts giving, by receiving the money and/or gifts, providing proof of donations to the donors for tax deduction purposes, and then giving away the gifts or spending the money for the particular charitable causes. For example, U.S. Pat. No. 6,519,573 describes a host operating a central server, such as a web site, and potentially other support services, such as telephonic support. A gift giver visits the host web site and selects a donation amount and a gift recipient. The host then transmits the charitable gift to the gift recipient, along with a unique code which enables the gift recipient to redeem the charitable gift.

The system described in U.S. Pat. No. 6,898,575 allows participating charitable institutions to identify goods and services needed and donors can donate money to be applied for those specific needs by the institutions. The system also provides an aggregation of participating merchants that provide goods and services needed by the charitable institutions that can be purchased by such institutions with a system debit card.

The system in US. Pub. No. 200200116214 allows a purchaser to select a beneficiary and predefines a donation percentage to a purchase/transaction amount to be donated from the merchant to the beneficiary.

US. Pub. No. 20050125342 provides an IVR system interacts with callers to conduct donation transactions between callers and caller-selected charitable or political entities.

The system in US. Pub. No. 20050159976 conducts a fundraising campaign over a wide-area network by hosting a website, registering on the website, making a charitable donation on the website, contacting third parties via email messages soliciting charitable donations, and providing one or more reports, on the website, including information on the status of the fundraising campaign.

Currently, there is a demand for a third party to the donation to facilitate charitable money and/or gifts donation in an hands-off manner, i.e., without receiving the donations and dispensing donation receipts.

### SUMMARY OF THE INVENTION

It is a purpose of this invention to bridge the gap between industry/community and education and to strengthen school outreach to the external community.

It is another purpose of this invention to connect businesses, communities and other donating organizations to the school starting from the donor's perspective and goals to appropriate school recipients.

It is still another purpose of this invention to provide a system by which private and community entities can donate according to their specified donation criteria while matching to the needs of the individual schools.

### BRIEF DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 shows a conceptual diagram according to the invention;

FIGS. 2A-2C are together a block diagram showing one embodiment of the overall hardware/software structure implementation of the system shown in FIG. 1;

FIG. 3 shows a sample match form prompted by the system to a donating entity; and

FIG. 4 shows a sample input form prompted by the system to a participating school.

### DESCRIPTION OF THE PREFERRED EMBODIMENTS

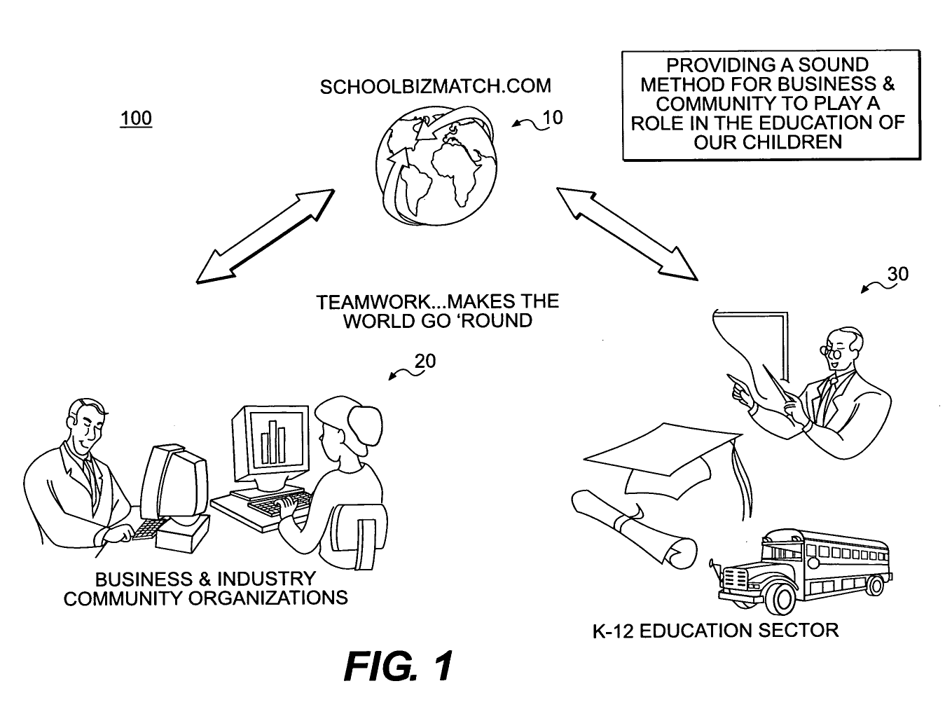

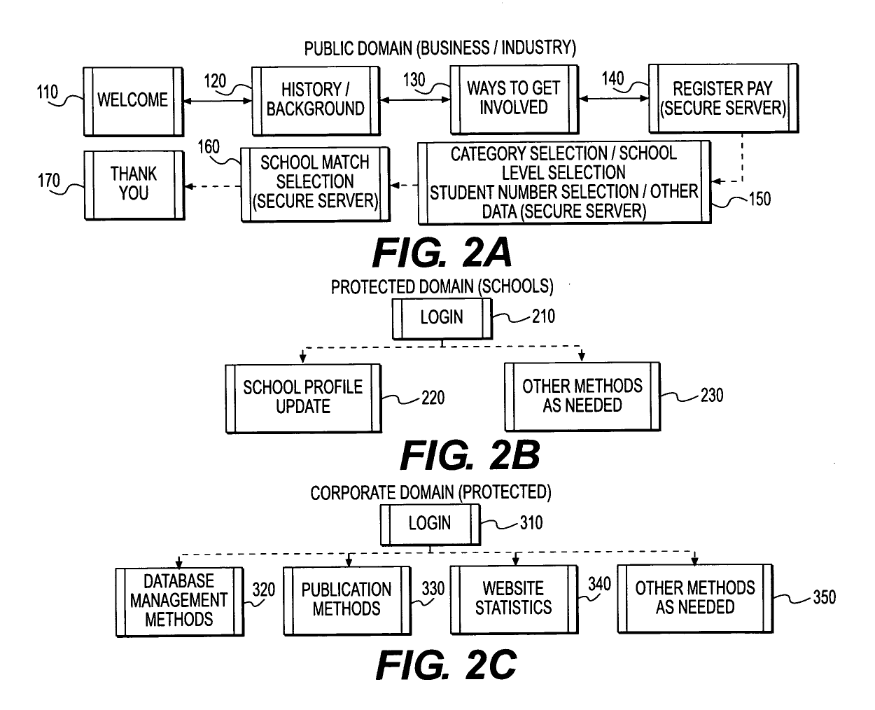

With reference to the figures, like reference characters will be used to indicate like elements throughout the several embodiments and views thereof. As shown in FIG. 1 illustrating the system 100 according to the invention (i.e., SchoolBizMatch) connects public or private donating entities 20 to direct donation receiving entities 30, such as schools in the K-12 education sector. Fortune Magazine reports that 50% of the K-12 public and private schools in the U.S. are partnered with business in some manner. The system 100 out-reaches to potential donating entities 20 and donation-receiving entities 30 via press-releases, e-mails, newsletters, etc. inviting them to visit a SchoolBizMatch website 10 in order to register their information into the sample flow charts shown in FIGS. 2A-C.

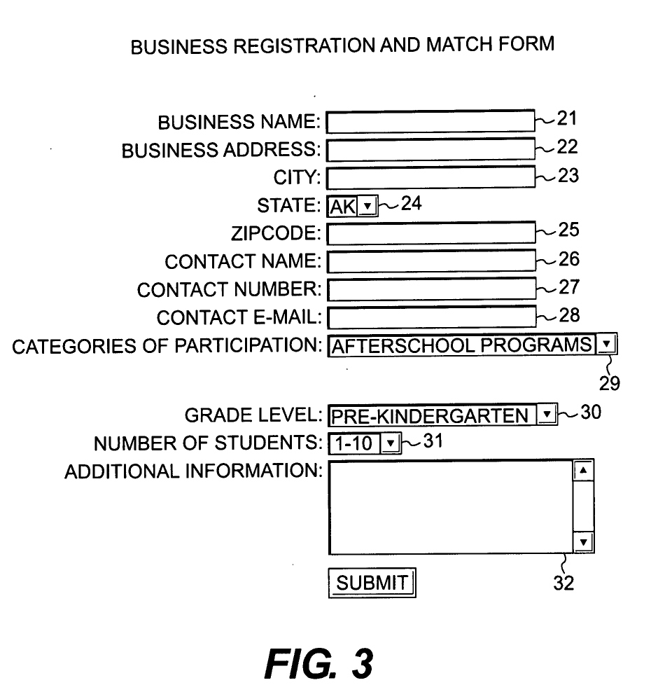

In FIG. 2A, the system 10 invites a potential donating entity 20 to become a partner in the SchoolBizMatch (SBM) website 10 via welcome page/step 110, and introduce the history and background of the system via a page/step 120. This website 10 offers to the business or community organization a tour of the educational framework and ways to get involved in a specific school or school system via a page/step 130. The system then invites the potential donating entity 20 to pay a flat surcharge (e.g., $95) in a page/step 140, to access information of donation receiving entities 30 collected and analyzed by the system. In the step 150, the system prompts a Registration and Match Form as shown in FIG. 3 to match automatically. The form includes a business name field 21, a business address field 22, a city field 23, a state field 24, a zip code field 25, a contact number field 26, a contact number field 27, a contact e-mail filed 28, a categories of participation field 29, a grade level field 30, a number of student field 31, and an additional information field 32. For example, the categories of participation field 29 shows a drop-down leaf listing: after school programs, arts education, athletics, business management, career development for students, early childhood education, facility and supply management, financial literacy, leadership for teachers and administrators, parental involvement, professional development for teachers, reading literacy, science literacy, tutoring and mentoring, etc. The grade level field 30 shows a drop-down leaf listing: pre-kindergarten, elementary, middle school, high school, etc.

According to FIG. 2C, the donating entity would enter data for the Registration and Match Form into a protected domain of the system. Specifically, the donating entity would login (step 310) into the protected domain; the domain is protected or secured in order to prevent the use of the donating entity's information by third parties accessing the website of the system 100. For example, securing the donating entity domain would prevent third party solicitations directed to the donating entity from other charities or fraudulent sources. The donating entity then enters its data according to the Registration and Match Form (see steps 110-150).

Once the Registration and Match Form is inputted into the system 100, the data is managed as a database according to step 320 so as to be available to match with the schools listed in the database of the system 100 as explained herein below.

As illustrated in FIG. 2B, the school enters the data from a needs analysis into another protected domain of the system. The needs analysis is a process conducted by the individual schools to identify the needs specific to that school. The details on the needs analysis process and how to conduct the process may be available to the schools through workshops, in-person classes or online classes. The substantive content of the needs analysis is based on SBM's High Performance School Place Model, a governance and inclusion process involving varied parties/stakeholders. The school would then login (step 210) into the protected domain; this domain is protected or secured due to the potentially sensitive and proprietary nature of the information relating to the school, its operation and its students.

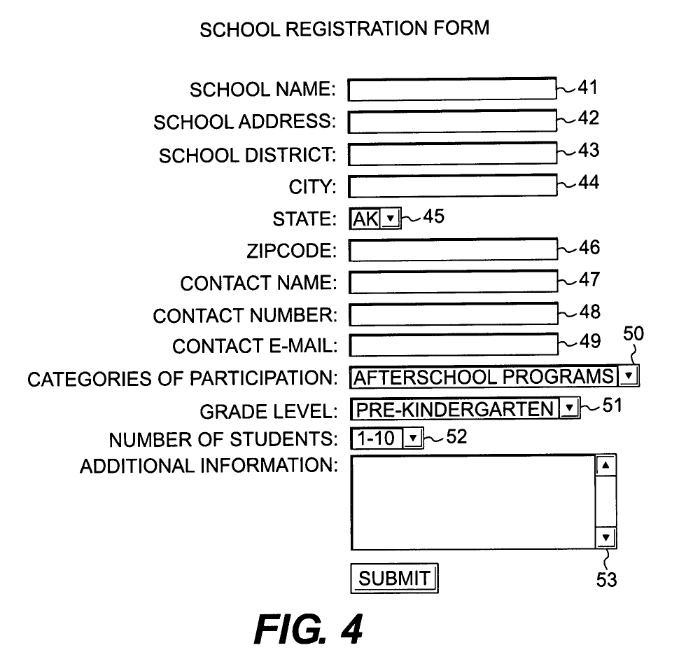

Under step 220, the system prompts a School Registration Form as shown in FIG. 4 in which the school inputs its data that then forms its school profile. This form includes a school name field 41, a school address field 42, a school district field 43, a city field 44, a state field 45, a zip code field 46, a contact name field 47, a contact number field 48, a contact e-mail field 49, a categories of participation or need field 50, a grade level field 51, a number of students field 52, and an additional information field 53. For example, the categories of participation/need field 50 shows a drop-down leaf (similar to that in the Registration and Match Form of FIG. 3) listing: after school programs, arts education, athletics, business management, career development for students, early childhood education, facility and supply management, financial literacy, leadership for teachers and administrators, parental involvement, professional development for teachers, reading literacy, science literacy, tutoring and mentoring, etc. The grade level field 51 shows a drop-down leaf listing: pre-kindergarten, elementary, middle school, high school, etc. For schools that have very specific needs not covered by the categories of participation/need field 50, schools may enter the details of such specific needs in the additional information field 53. Examples of such special needs include special education materials, facilities or equipment to accommodate disabled students, mentoring support for low income or single parent families.

Alternatively, school profile data may be entered into the system 100 other methods as noted in step 230. For example, state, county or other local government agencies responsible for the local school system may have already collected the same or equivalent data on the school(s) in a database that could then be transferred or converted into the appropriate database format that can be accessed and manipulated by the system 100. Also, those same sources could be used to provide the national/regional needs analysis data that the donating entity 20 could review manually to determine its participation, instead of through the matching of step 160.

As shown in FIG. 2A, when the school matching selection process is used, the system 100 then proceeds to match the donating entity 20 with one or more donation receiving entities 30 in step 160 based on the school profile data process of step 220 and the database management method of step 320, as will be explained further below. The system 100 then shows the match results and a thank you screen to the donating entity 20 in a step 170. The system will also inform the matched donation receiving entities 30 if the donating entity 20 so requests. However, the system 100 will not be involved in actual contact and communication between the matched donating entity 20 and donation receiving entities 30. However, the system will coach the donation receiving entities 30 to function like a stand-alone charity organization to negotiate the donation, to receive the donation, and to issue donation receipts on it own.

As an alternative to the matching step 160, the donating entity 20 may review the inputted needs analysis from step 220 or a national/regional needs analysis provided by a third party participant that made its data available to the system 100 to determine which level of school, which category of programs, and to which school or schools to donate using the publication method (see step 330); namely the system 100 in effect publishes the data on all participating schools only to the donating entry 20 to allow them to manually select their participation. As further alternatives, the system 100 may import or make available to the donating entity 20 other types of information or other sources of information on schools having identifiable needs, such as through information from website statistics (see step 340) or other data gathering/collection methods (see step 350).

In addition to the above-described matching process, the system 100 invites potential donation receiving entities 30 to register on the website 10 and attend an online or actual “When Your Partner Calls” workshop to help them deal effectively with business or community partners.

The workshop conveys school-business partnership ideas; what schools can do for their partners and what business and communities can do for the school, new ways to bring in business and community support, sample school-business partnership ‘contracts,’ benchmarking a partnership's progress, evaluation tools for continued or new partnership programs, benefits to schools, business, and community, understanding the ‘business of business’, dimensions of leadership, the difference between leadership and management, teamwork techniques, public relations ideas for schools and business, grass roots needs assessment for the school, etc.

Through this SchoolBizMatch web-enabled initiative, businesses and other users can register to help meet school needs and have a real hand in community development. SBM's strategy puts schools in the forefront, enabling them to receive valuable input and assets from private and public entities with the focus on student achievement.

Although the ultimate goal of SchoolBizMatch is to facilitate the matching process, this website has the potential to be a clearinghouse for information on policy and programs for educational excellence and civic involvement that benefits schools, students, communities, and business partners.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A computer-implemented method for facilitating charity donation transactions, comprising:
collecting information of potential donation receiving entities;
inviting a potential donating entity to register contact information and donation criteria;
prompting the potential donating entity to pay a matching surcharge;
accepting the matching surcharge; and
matching the potential donating entity with one or more potential donation receiving entities and generating matching results; and
providing the matching results to the potential donating entity.

2. The computer-implemented method for facilitating charity donation transactions according to claim 1, further comprising:
displaying a national/regional needs analysis to the potential donating entity thereby assisting the potential donating entity to determine said donation criteria.

3. The computer-implemented method for facilitating charity donation transactions according to claim 1, further comprising:
informing the matched donation receiving entities if the donating entity so requests.

4. The computer-implemented method for facilitating charity donation transactions according to claim 1, further comprising:
coaching the matched donation receiving entities to function as a stand-alone charity organization to negotiate the donation, to receive the donation, and to issue donation receipts independently.

5. A software program embedded in a computer readable medium for facilitating charity donation transactions, comprising:
a module for collecting information of potential donation receiving entities;
a module for inviting a potential donating entity to register contact information and donation criteria;
a module for prompting the potential donating entity to pay a matching surcharge;
a module for accepting the matching surcharge; and
a module for matching the potential donating entity with one or more potential donation receiving entities and generating matching results; and
a module for providing the matching results to the potential donating entity.

6. The software program according to claim 5, further comprising:
a module for displaying a national/regional needs analysis to the potential donating entity thereby assisting the potential donating entity to determine said donation criteria.

7. The software program according to claim 5, further comprising:
a module for informing the matched donation receiving entities if the donating entity so requests.

8. The software program according to claim 5, further comprising:
a module for coaching the matched donation receiving entities to function as a stand-alone charity organization to negotiate the donation, to receive the donation, and to issue donation receipts independently.
